(19) United States
(12) Patent Application Publication
(10) Pub. No.: US 2022/0162816 A1
(43) Pub. Date: May 26, 2022

(54) LUMINESCENT ROAD MARKINGS

(71) Applicant: Elijah H. Hankerson, III, (US)

(72) Inventor: Rachel Hankerson, Florissant, MO (US)

(21) Appl. No.: 17/520,554

(22) Filed: Nov. 5, 2021

Related U.S. Application Data
(60) Provisional application No. 63/110,874, filed on Nov. 6, 2020.

(51) Int. Cl. E01F 9/518; C09K 11/06; C09K 11/70

(52) U.S. Cl. CPC E01F 9/518; C09K 2211/1007; C09K 11/70; C09K 11/06

(57) ABSTRACT

Methods and systems for marking roads include providing a luminescent marking solution applied to a surface of a road to form a luminescent marking. The luminescent marking is shaped to indicate information to a driver of a vehicle on the road and is configured to emit light that is visible to the driver.

### CROSS-REFERENCE TO RELATED APPLICATIONS

This application claims priority to U.S. Provisional Patent Application Ser. No. 63/110,874, filed Nov. 6, 2020, the entire contents of which are incorporated herein by reference in its entirety.

### BACKGROUND

The field of the disclosure relates generally to systems and methods for marking roads and, more particularly, to systems and methods for forming luminescent road markings.

Roads are often marked to indicate directions of travel, lane separations, potential hazards, and other useful information for drivers. Accordingly, road markings allow for the safe travel of vehicles on roads. Sometimes visibility on the roads may be decreased and the road markings may be difficult for a driver to see. For example, the road markings may be difficult to see during the night, during inclement weather, or when the road surface is obscured by debris or precipitation. Sometimes, reflectors or lights are positioned along roads to help drivers when the road markings may not be visible. However, the lights and reflectors are not positioned along the entirety of every road and do not provide complete visibility of the road markings. In addition, reflectors require external light sources. Typical lights include power source and may not be able to be placed at all locations and may cost money to operate. Moreover, the lights and reflectors may require regular maintenance and may be damaged and not function properly at times.

Accordingly, there is a need for systems and methods to improve visibility of road markings during inclement weather or other periods of low visibility.

### BRIEF DESCRIPTION

In one aspect, a method for marking a road includes providing a luminescent material and mixing the luminescent material with a marking material to form a luminescent marking solution. The method also includes applying the luminescent marking solution onto a road surface to form a luminescent marking. The luminescent marking is shaped to indicate information to a driver of a vehicle on the road and is configured to emit light that is visible to the driver.

In another aspect, a road marking system includes a luminescent marking solution applied to a surface of a road to form a luminescent marking. The luminescent marking is shaped to indicate information to a driver of a vehicle on the road and is configured to emit light that is visible to the driver.

In yet another aspect, a luminescent marking solution for forming a luminescent marking on a surface of a road is shaped to indicate information to a driver of a vehicle on the road and is configured to emit light that is visible to the driver. The luminescent marking solution comprises at least one luminescent material mixed with a liquid marking material.

### BRIEF DESCRIPTION OF THE DRAWINGS

FIG. 1 is a schematic view of a road marking system comprising luminescent markings formed from a luminescent marking solution applied to a surface of a road.

FIG. 2 is a schematic view of a system for marking a road with luminescent markings.

FIG. 3 is a picture illustrating a road without luminescent markings.

FIG. 4 is a picture illustrating the road shown in FIG. 1 with luminescent markings.

FIG. 5 is a picture illustrating a road without luminescent markings.

FIG. 6 is a picture illustrating the road shown in FIG. 5 with luminescent markings.

FIG. 7 is a flow chart of a method of marking a road with luminescent markings using a luminescent solution including phosphorus powder.

FIG. 8 is a flow chart of a method of marking a road with luminescent markings using a chemiluminescent solution.

FIG. 9 is a diagram of a chemical structure for a luminescent material for use in forming luminescent markings.

FIG. 10 is a diagram of an alternative chemical structure for a luminescent material for use in forming luminescent markings.

FIG. 11 is a flow chart of another embodiment of a method of marking a road with luminescent markings.

### DETAILED DESCRIPTION

As used herein, the terms “luminescent” and “luminescence” refer to materials that emit light. Luminescent materials may emit light as a result of a physiological process, a chemical action, or electrical energy. Luminescent materials emit light that is not from heat. Luminescent materials are distinguished from reflective materials because luminescent materials spontaneously emit light without requiring an external light source. Examples of types of luminescent include chemiluminescent and phosphorescent.

As used herein, the terms “chemiluminescent” and “chemiluminescence” refer to luminescent materials that emit light due to a chemical action. Chemiluminescent materials do not produce a significant amount of heat when emitting light as a result of the chemical action.

As used herein, the terms “phosphorescent” and “phosphorescence” refer to luminescent materials that can store absorbed light and can emit the light over a period of time, in the form of glow. For example, phosphorescent materials may store the absorbed light energy and emit light that has a longer wavelength. The phosphorescent materials may emit light when there is little or no external light (i.e., the phosphorescent materials may “glow-in-the-dark”).

Example embodiments of systems and methods for luminescent road markings are described. The systems and methods may include applying a marking material including a luminescent material to the surface of roads to make road markings that emit light, i.e., glow. The marking material is applied to the road surface to form luminescent road markings that indicate information to a driver on the road. For example, the luminescent road markings may indicate lane separations, turn arrows, potential hazards, passing zones, no-passing zones, upcoming traffic control measures, shoulder locations, and any other useful information for a driver. The marking material may be applied on top of or adjacent to existing road markings or as new markings directly onto the road surface. The color of the luminescent road markings may be selected based on visibility in certain conditions. For example, the luminescent material may emit light that is blue, yellow, green, red, orange, or mixtures thereof. In some embodiments, luminescent road markings having different colors are used to convey different information to drivers on the road.

In embodiments, a method of applying road markings includes forming a luminescent solution. In some embodiments, the luminescent solution includes a phosphorus powder that is mixed with a paint or marking solution. The marking solution may include an oil-based acrylic gel paint, a tempera paint or any other paint combined with a thermoplastic marking compound or a synthetic resin. In further embodiments, the luminescent solution may include diphenyloxalate ester and may be formed from 246 trichlorophenyl, toluene, triethylamine, and/or oxalyl chloride. The luminescent solution may be stored in a container that can be transported along the road by a vehicle. As the vehicle moves along the road, the luminescent solution may be dispensed from the container and deposited on the road surface to form luminescent road markings. In some embodiments, the luminescent solution is applied on top of or adjacent to existing road markings. The luminescent solution may adhere to the surface to form a luminescent marking which emits light. Accordingly, the luminescent marking is easily visible for a driver even during decreased visibility conditions.

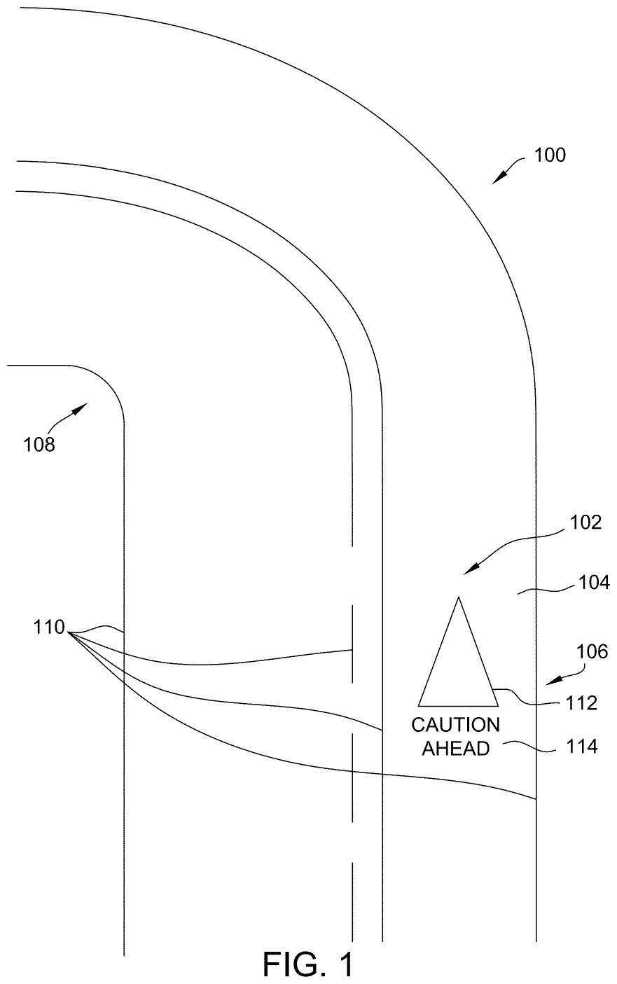

FIG. 1 is a schematic view of a road marking system 100 comprising luminescent markings 102 formed from a luminescent marking solution applied to a surface 104 of a road 106. The road 106 is configured for vehicles to travel along between one or more locations. For example, the surface 104 or the sublayers of the road may be concrete, asphalt, dirt, gravel, rubber, recycled materials or any other material. The road 106 and/or the ground underneath the road may be graded and compacted to facilitate the surface 104 being relatively smooth and firm. The vehicles may travel on the road 106 in different directions.

In the example, the road 106 is a two-lane road arranged for vehicles to travel in two opposing directions. The road 106 includes a bend or curve 108. In further embodiments, the road 106 may include intersections, turn-offs, merging lanes, additional traffic lanes, or any other features.

The road marking system 100 facilitates the drivers safely driving on the road 106 because the luminescent markings 102 are shaped to indicate information to a driver of a vehicle on the road and are configured to emit light that is visible to the driver. For example, the luminescent markings 102 include lane lines 110 that extend in a direction of travel of the vehicles and designates lane for the vehicles to travel in. In addition, the lane lines 110 in the center of the road indicates two way traffic. Portions of the lane lines 110 are solid to indicate that vehicles are not allowed to pass other vehicles (e.g., a no passing zone). Other portions of the lane lines are broken to indicate that vehicles are allowed to pass other vehicles (e.g., a passing zone). In addition, lane lines 110 along the sides of the road 106 are solid and indicate an edge or shoulder of the road. In some embodiments, the lane lines 110 are colored to provide additional information to drivers (e.g., lane lines are colored white to indicate one-way traffic or yellow to indicate two-way traffic).

The luminescent markings 102 also include an image 112 and a written message 114. In the example, the image 112 is a geometric shape. In particular, the image 112 is a triangle. In other embodiments, the image 112 may include other geometric shapes such as rectangles, circles, and polygons. In further embodiments, the image 112 may include illustrations of, for example, people, animals, or traffic hazards. The luminescent markings 102 indicate a potential hazard ahead and direct drivers that it may be appropriate to slow down for the turn. For example, the image 112 and the written message 114 are positioned to be visible to a driver approaching the turn 108. In other embodiments, the luminescent markings 102 may indicate intersections, cross-walks, animal crossings, presence of rocks or obstacles, reduced speed zones, no-passing/passing zones, traffic signals ahead, traffic signs ahead, merging traffic, lane changes or shifts, express lane/high occupancy vehicle information, bus route information, non-motorized vehicle information, turn lanes, toll information, and any other information to facilitate driving on the road 106.

The luminescent markings 102 are visible throughout the day and night and in different weather or road conditions because the luminescent markings 102 emit light without an external light source. During daytime and in clear conditions, the luminescent markings 102 are visible in the sunlight. In addition, the luminescent markings 102 are visible at nighttime or during reduced visibility situations because the luminescent markings emit light or glow. The luminescent markings 102 stand out from the surface 104 of the road 106 and other objects around because the luminescent markings 102 emit light that is detected by the human eye (i.e., the light has a wavelength that is in the visible spectrum) and the surface of the road and other objects do not emit light. The light may be brighter and a different color than the other objects. For example, the light emitted by the luminescent markings 102 may be blue, green, yellow-green, yellow, orange, or red. Accordingly, the luminescent markings 102 catch the attention of a driver and provide essential information to facilitate the driver safely driving on the road even during difficult road conditions.

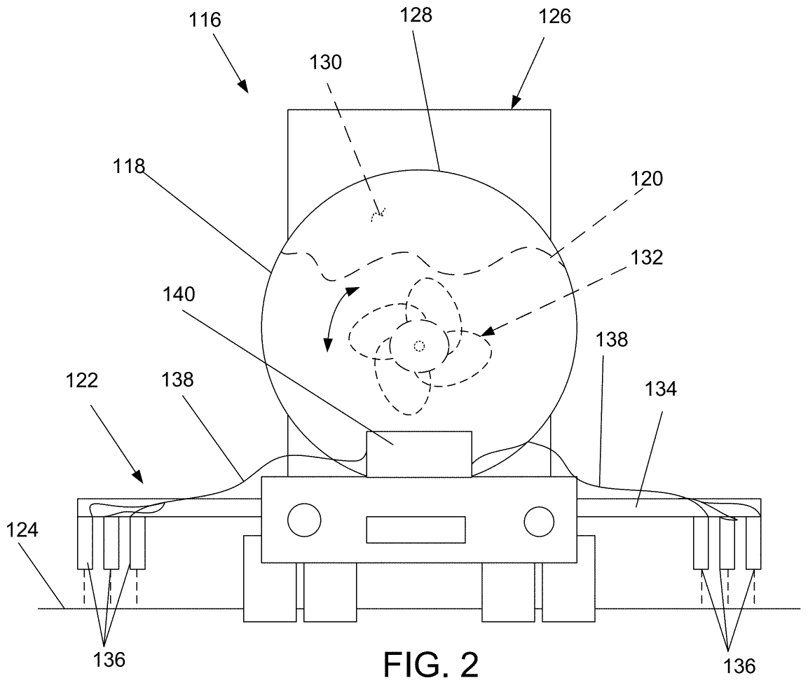

FIG. 2 is a schematic view of a system 116 for marking a road (e.g., road 106) with luminescent markings (e.g., luminescent markings 102). The system 116 includes a tank or storage vessel 118 for holding a luminescent marking solution 120, and an application system 122 for applying the luminescent marking solution 120 to a surface 124. In the example, the tank 118 and the application system 122 are mounted to or otherwise transported by a vehicle 126 along the road before and during application of the luminescent marking solution 120 to the road. In other embodiments, at least a part of the tank 118 or the application system 122 may be separate from the vehicle.

The tank 118 includes an outer wall 128 defining a cavity 130 to receive the luminescent marking solution 120. In some embodiments, a luminescent material and a liquid or semi-liquid material are positioned with the cavity 130 and mixed to form the luminescent marking solution 120. In further embodiments, the luminescent marking solution 120 is formed remotely and inserted into the cavity 130 of the tank 118. The tank 118 may include an inlet, an outlet, and one or more valves that facilitate inserting and/or removing the luminescent marking solution 120 from the cavity 130.

An agitator 132 is mounted within the cavity 130 of the tank 118 and arranged to mix or agitate the luminescent marking solution 120 to achieve or maintain a desired state and consistency of the solution. In the example, the agitator 132 comprises an auger that rotates around an axis extending longitudinally through a center of the tank 118.

The application system 122 includes a boom 134, at least one nozzle 136, conduits 138, and a pump 140. In the example, the at least one nozzle 136 comprises an array of nozzles 136 that are mounted along the boom 134. The boom 134 extends outward from the sides of the vehicle 126 and is arranged for the luminescent marking solution 120 to be sprayed onto the surface through the nozzles 136 on either side of the vehicle 126. The conduits 138 extend between and fluidly connects the nozzles 136 and the pump 140. The pump 140 is arranged to withdraw the luminescent marking solution 120 from the tank 118 and provide the solution to the nozzles 136 at a desired pressure. In other embodiments, the pump 140 may be omitted.

During operation, the vehicle 126 transports the application system 122 and the tank 118 with the luminescent marking solution 120 along the road. The luminescent marking solution 120 is mixed within the cavity 130 by the agitator 132 to maintain the solution in a liquid or semi-liquid state. The pump 140 withdraws the luminescent marking solution from the tank 118 and provides the solution to the nozzles 136, via the conduits 138. The nozzles 136 are configured to emit the luminescent marking solution 120 in a desired pattern to form the luminescent markings on the road. For example, one or more of the nozzles 136 are actuated or operated to emit the luminescent marking solution 120 in a pattern to form markings 102 (shown in FIG. 1). The nozzles 136 and the pump 140 may be operated by a controller within the vehicle and/or a remote controller.

The luminescent marking solution 120 dries or cures to form the luminescent markings 102. The luminescent markings 102 are permanent, i.e., the luminescent markings 102 do not wash off with liquids or come off due to contact. Accordingly, the luminescent markings 102 are configured to withstand traffic on the roads and the environment. The marking material used in the luminescent marking solution may provide the durability and adherence of the luminescent marking solution 120. The luminescent material provides the luminescent properties for the luminescent markings 102.

As a result, the described system is able to form luminescent markings quickly and simply on roads. The luminescent markings may be less expensive than other visibility systems. In addition, the luminescent markings may be accustomed to many different shapes and to convey any desired information. Moreover, the luminescent markings may be applied to any surface in any location such as remote roadways.

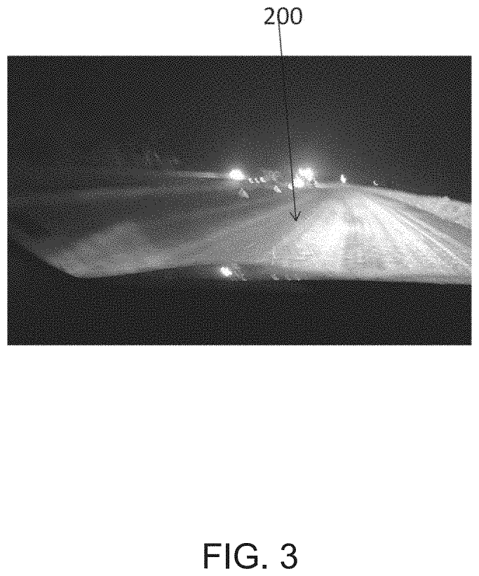

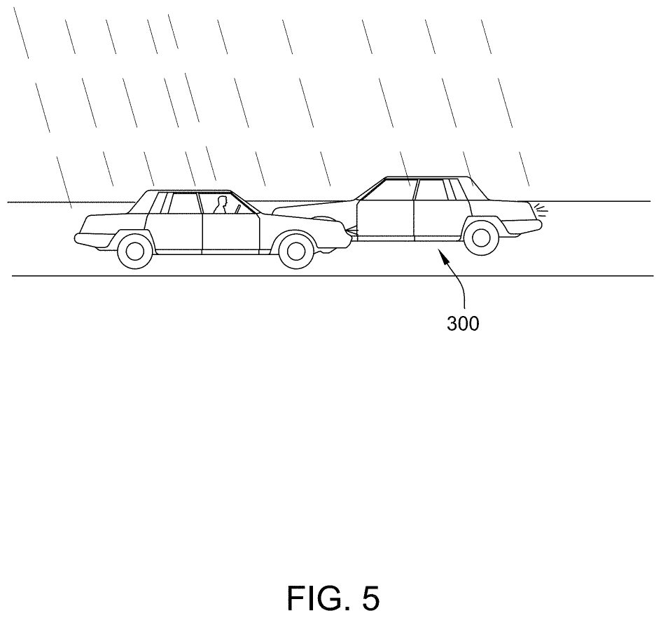

FIGS. 3 and 5 are perspective views of roads 200, 300 without luminescent markings. Visibility conditions along the roads 200, 300 are decreased due to precipitation such as rain, sleet, and/or snow which is falling from the sky and is collecting on the road surface. As a result, any markings on the roads 200, 300 such as lane markings may not be visible to drivers of vehicles on the road.

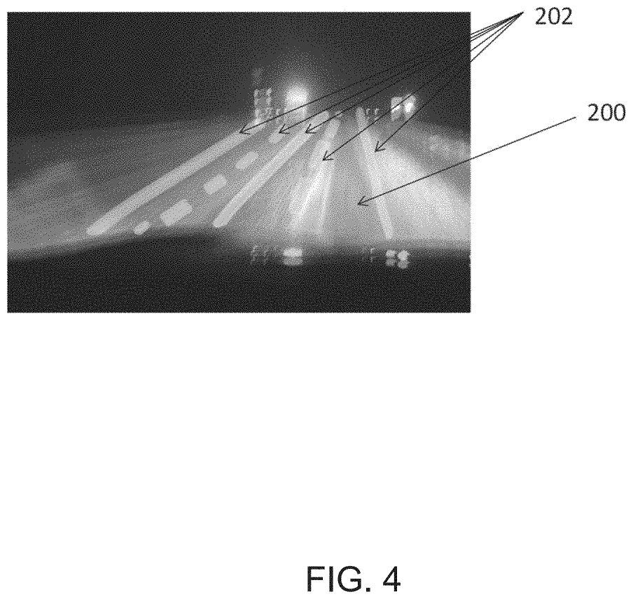

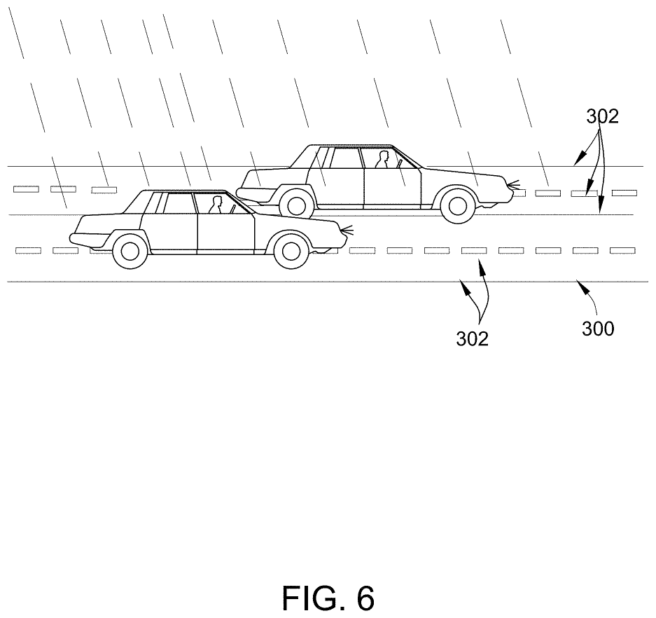

FIGS. 4 and 6 are perspective views of the roads 200, 300 with luminescent markings 202, 302. The luminescent markings 202, 302 emit colored light and are clearly visible to drivers of vehicles on the roads 200, 300 even during the conditions of low visibility shown in FIGS. 4 and 6. For example, the luminescent markings 202, 302 may include chemiluminescent and/or phosphorescent materials. The luminescent markings 202, 302 include solid and broken lines indicating separate lanes of traffic and two-way traffic. Accordingly, the luminescent markings 202, 302 may help drivers follow lanes in the roads and may prevent collisions between vehicles driving in the same or different directions and/or prevent vehicles driving off of the road. In an example, the luminescent markings 202, 302 emit yellow light. In some embodiments, the luminescent markings 202, 302 may emit light that is blue, yellow, green, red, orange, or mixtures thereof.

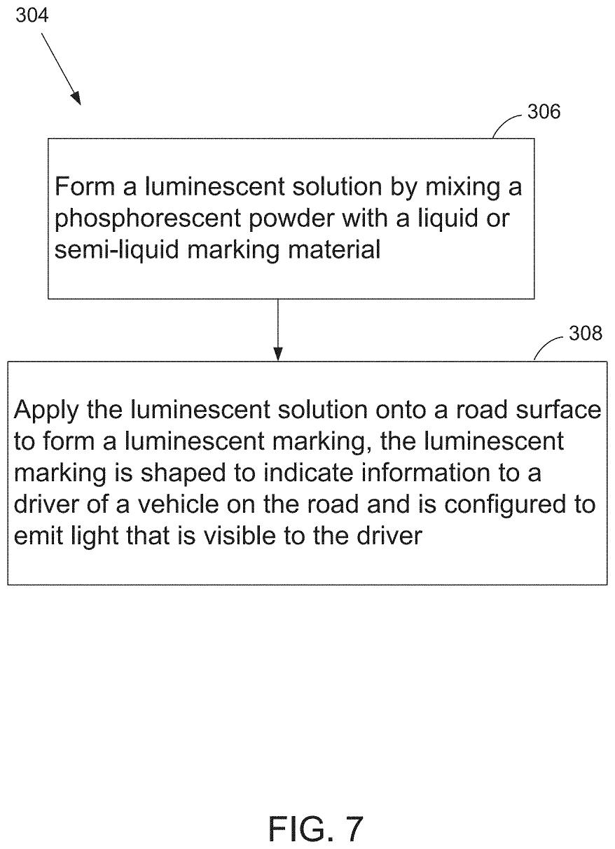

FIG. 7 is a flow chart of a method 304 of marking a road with luminescent markings. Method 304 includes forming 306 a luminescent solution by mixing a phosphorus powder with a liquid or semi-liquid marking material. For example, the marking material may include a paint such as an oil-based acrylic gel paint or a tempera paint. In addition, the marking material may include a thermoplastic marking compound or a synthetic resin. The phosphorus powder may be colored blue, green, yellow-green, yellow, orange, or red such that the luminescent markings emit blue, green, yellow-green, yellow, orange, or red colored light.

The method 304 also includes applying 308 the luminescent solution onto a road surface to form a luminescent marking. The luminescent marking is shaped to indicate information to a driver of a vehicle on the road and is configured to emit light that is visible to the driver. In some embodiments, the luminescent solution is stored in a container transported by a vehicle and the method 304 includes dispensing the luminescent solution from the container as the vehicle travels along the road.

The luminescent solution may be applied to any suitable roads or surfaces. In some embodiments, the luminescent solution is applied to the road on top of or adjacent to an existing road marking. In further embodiments, the luminescent solution is applied to a road to form new markings.

The luminescent markings may spontaneously emit light due to any luminescent process. In the example, the luminescent solution is chemiluminescent and emits light due to a chemical action. For example, the luminescent solution may spontaneously emit light when exposed to a chemical reactant such as oxygen in the ambient air. In some embodiments, the luminescent solution is phosphorescent. Accordingly, the luminescent markings emit light and are clearly visible to drivers on the roads even during periods of decreased visibility such as during night time or inclement weather.

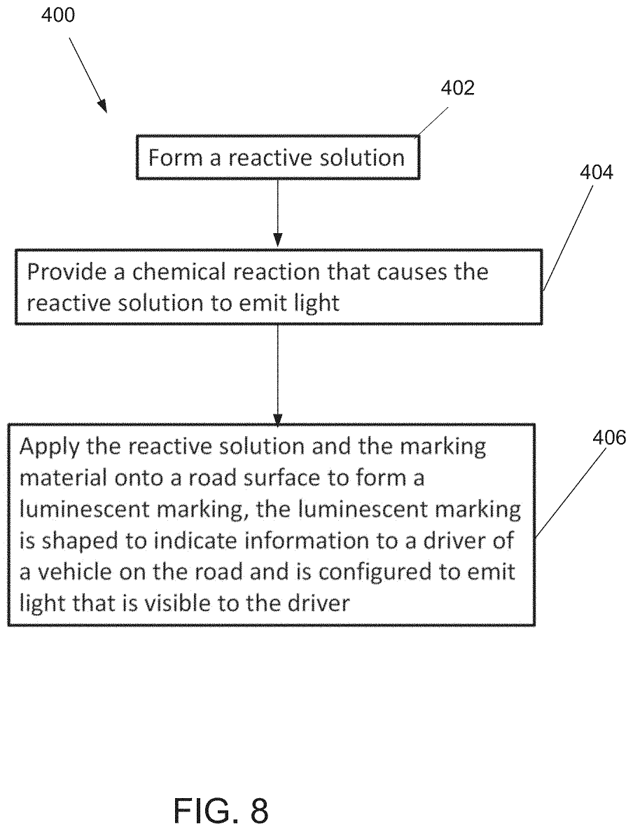

FIG. 8 is a flow chart of a method 400 of marking a road with luminescent markings. Method 400 includes forming 402 a chemiluminescent solution and providing 404 a chemical reaction that causes the chemiluminescent solution to emit light. For example, the chemiluminescent solution may include trichlorophenyl. The trichlorophenyl may be combined with diphenyloxalate ester, hydrogen peroxide, and any other suitable materials. The chemiluminescent solution may have a chemical reaction that releases colored light. For example, the chemical reaction may activate a dye which then releases photons of light. The dye may be colored blue, green, yellow-green, yellow, orange, or red such that the luminescent markings emit blue, green, yellow-green, yellow, orange, or red colored light.

The method 400 also includes applying 406 the chemiluminescent solution and a marking material onto a road surface to form a luminescent marking. The chemiluminescent solution and/or the chemical reactive agent may be mixed with a marking material (luminescent or non-luminescent material) such that the chemiluminescent solution increases the luminescent properties of the marking material. The luminescent marking is shaped to indicate information to a driver of a vehicle on the road and is configured to emit light that is visible to the driver. In some embodiments, the chemiluminescent solution is stored with a marking material in a container transported by a vehicle and the method 400 includes dispensing the chemiluminescent solution and the marking material from the container as the vehicle travels along the road. The chemical reactive agent may be transported and dispensed separately or with the chemiluminescent solution.

The chemiluminescent solution may be applied to any suitable roads or surfaces. In some embodiments, the marking material, the chemiluminescent solution, and the chemical agent are applied to the road on top of or adjacent to an existing road marking. In further embodiments, the chemiluminescent solution is applied to a road to form new markings.

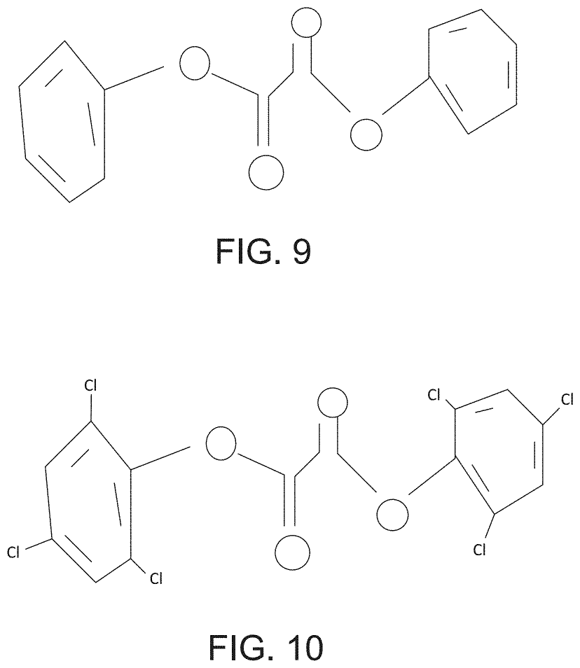

FIGS. 9 and 10 are diagram of chemical formulas for use in forming luminescent markings. For example, the chemiluminescent solution for the luminescent markings may be formed from 8 grams of 246 trichlorophenyl, 100 milliliters of toluene, 4 grams of triethylamine, and 3 grams of oxalyl chloride. In other embodiments, the chemiluminescent solution may be formed from any suitable components.

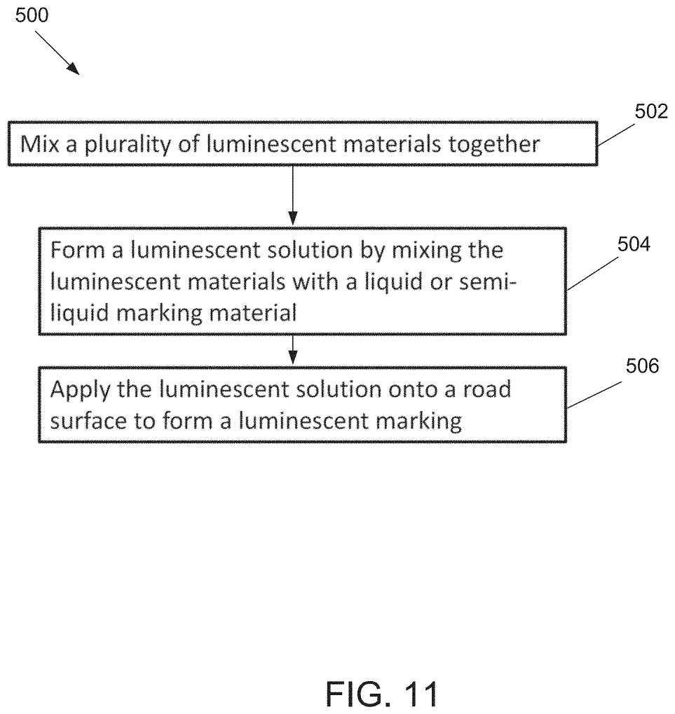

FIG. 11 is a flow chart of a method 500 of marking a road with luminescent markings. Method 500 includes mixing 502 a plurality of luminescent materials together. For example, the luminescent materials may include phosphorus powder and trichlorophenyl. The method 500 also includes forming 504 a luminescent solution by mixing the luminescent materials with a liquid or semi-liquid marking material. The luminescent materials may be mixed together before, simultaneously with, or after mixing the luminescent materials with the marking material. The method 500 also includes applying 506 the luminescent solution onto a road surface to form a luminescent marking. The luminescent markings formed from the luminescent solution produced by method 500 may emit more light, appear brighter, and provide increased visibility when applied to the surface because the luminescent solution includes more than one luminescent materials.

The luminescent solution may be applied to any suitable roads or surfaces. In some embodiments, the luminescent solution is applied to the road on top of or adjacent to an existing road marking. In further embodiments, the luminescent solution is applied to a road to form new markings.

### Example

An example luminescent material for forming the luminescent markings described herein includes generic diphenyloxazole ester. FIGS. 9 and 10 show example chemical structure for generic diphenyloxazole ester. Diphenyloxazole ester has a basic structure with many different forms that are well understood in the field. For example, in some forms, such as in the structure shown in FIG. 10, diphenyloxazole ester may include chlorine (Cl).

A source of luminescent material is bis (2,4,6-trichlorophenyl)oxalate (TCPO). The luminescent material may be made from 8 grams of 2,4,6-trichlorophenyl)oxalate, 100 milliliters of toluene, 4 grams of triethylamime, and 3 grams of oxalyl chloride. The materials are combined and mixed to form the luminescent material. As a result, the listed material provide luminescent properties for the luminescent material such that the luminescent material can emit light without an external light source.

In other embodiments, the luminescent material may have any structures and include any materials that are understood to provide similar luminescent properties.

When introducing elements of the present invention or the preferred embodiment(s) thereof, the articles “a”, “an”, “the” and “the” are intended to mean that there are one or more of the elements. The terms “comprising”, “including” and “having” are intended to be inclusive and mean that there may be additional elements other than the listed elements. Moreover, the use of “top”, “bottom”, “above”, “below” and variations of these terms is made for convenience, and does not require any particular orientation of the components.

As various changes could be made in the above without departing from the scope of the invention, it is intended that all matter contained in the above description and shown in the accompanying drawings shall be interpreted as illustrative and not in a limiting sense.

What is claimed is:

1. A method for marking a road, said method comprising:
providing a luminescent material;
mixing the luminescent material with a marking material to form a luminescent marking solution; and
applying the luminescent marking solution onto a road surface to form a luminescent marking, the luminescent marking is shaped to indicate information to a driver of a vehicle on the road and is configured to emit light that is visible to the driver.

2. A method in accordance with claim 1, wherein the luminescent material comprises a phosphorus powder, and wherein mixing the luminescent material with the marking material to form the luminescent marking solution comprises mixing the phosphorus powder and a liquid or semi-liquid marking material.

3. A method in accordance with claim 1, wherein the luminescent marking solution includes a dye and the luminescent marking is configured to emit colored light.

4. A method in accordance with claim 3, wherein the colored light is blue, green, yellow-green, yellow, orange, or red.

5. A method in accordance with claim 1, further comprising storing the luminescent marking solution in a container transported by a vehicle.

6. A method in accordance with claim 5, further comprising dispensing the luminescent marking solution from the container as the vehicle travels along the road.

7. A method in accordance with claim 1, wherein the luminescent marking solution is applied to the road on top of or adjacent to an existing road marking.

8. A method in accordance with claim 1, wherein forming the luminescent material comprises forming a chemiluminescent solution including trichlorophenyl.

9. A road marking system comprising a luminescent marking formed from a luminescent marking solution applied to a surface of a road, the luminescent marking is shaped to indicate information to a driver of a vehicle on the road and is configured to emit light that is visible to the driver.

10. A road marking system in accordance with claim 9, wherein the luminescent marking solution includes a phosphorus powder.

11. A system in accordance with claim 9, wherein the luminescent marking includes a dye and is configured to emit colored light.

12. A system in accordance with claim 11, wherein the colored light is blue, green, yellow-green, yellow, orange, or red.

13. A system in accordance with claim 9, wherein the luminescent marking solution includes trichlorophenyl.

14. A system in accordance with claim 9, wherein the luminescent markings include at least one of the following markings: an arrow, broken lines, and solid lines.

15. A luminescent marking solution for forming a luminescent marking on a surface of a road, the luminescent marking is shaped to indicate information to a driver of a vehicle on the road and is configured to emit light that is visible to the driver, the luminescent marking solution comprises at least one luminescent material mixed with a liquid marking material.

16. A luminescent marking solution in accordance with claim 15, wherein the luminescent material comprises a phosphorus powder.

17. A luminescent marking solution in accordance with claim 15, wherein the luminescent marking solution includes a dye and the luminescent marking is configured to emit colored light.

18. A luminescent marking solution in accordance with claim 17, wherein the dye is blue, green, yellow-green, yellow, orange, or red.

19. A luminescent marking solution in accordance with claim 15, wherein the luminescent material comprises a chemiluminescent solution including trichlorophenyl.

20. A luminescent marking solution in accordance with claim 15, wherein the at least one luminescent material comprises a plurality of luminescent materials.
